(19) United States
(12) Patent Application Publication
(10) Pub. No.: US 2015/0055655 A1
(43) Pub. Date: Feb. 26, 2015

(54) SYSTEM AND METHOD FOR FORWARDING OF A PACKET

(71) Applicant: CISCO TECHNOLOGY, INC., San Jose, CA (US)

(72) Inventor: Hari Krishna Katakam, BANGALORE (IN)

(73) Assignee: CISCO TECHNOLOGY, INC., San Jose, CA (US)

(21) Appl. No.: 13/975,916

(22) Filed: Aug. 26, 2013

(51) Int. Cl. H04L 12/743; H04L 12/56

(52) U.S. Cl. CPC H04L 45/7457; H04L 45/741
USPC 370/392

(57) ABSTRACT

A method is provided in one example and includes receiving, at a head switch, a packet that comprises information indicative of a destination media access control address and a destination domain address, determining that the destination media access control address fails to correlate with at least one stored media access control address comprised by a content addressable memory table, determining a different head switch media access control address based, at least in part, on the destination domain address, generating an encapsulated packet that comprises at least one encapsulation portion and at least one packet portion, the packet portion corresponding to the packet, such that the encapsulation portion of the encapsulated packet designates the different head switch media access control address, and forwarding the encapsulated packet based, at least in part, on the different head switch media access control address.

### TECHNICAL FIELD

This disclosure relates in general to the field of communications and, more particularly, to forwarding of a packet.

### BACKGROUND

As data centers continue to grow, system limitations and content addressable memory restrictions may impact the ability for a network node to learn a sufficient number of media access control addresses. In such a situation, it may be desirable to allow for the scaling of content addressable memory in order to allow for the learning of additional media access control addresses.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram showing an apparatus according to at least one example embodiment;

FIG. 2 is a simplified block diagram showing apparatus communication according to at least one example embodiment;

FIGS. 3A-3D are simplified interaction diagrams showing activities associated with forwarding of a packet according to at least one example embodiment;

FIGS. 4A-4B are simplified block diagrams showing encapsulation of a packet according to at least one example embodiment;

FIG. 5 is a simplified flowchart showing activities associated with forwarding a packet according to at least one example embodiment;

FIG. 6 is a simplified flowchart showing activities associated with forwarding a packet according to at least one example embodiment; and

FIG. 7 is a simplified flowchart showing activities associated with forwarding a packet according to at least one example embodiment.

### DETAILED DESCRIPTION OF EXAMPLE EMBODIMENTS

### Overview

One or more embodiments may provide an apparatus, a computer readable medium, a non-transitory computer readable medium, a computer program product, and a method for receiving, at an apparatus, a packet that comprises information indicative of a destination media access control address and a destination domain address, determining that the destination media access control address fails to correlate with at least one stored media access control address comprised by a content addressable memory table, determining a different head switch media access control address based, at least in part, on the destination domain address, generating an encapsulated packet that comprises at least one encapsulation portion and at least one packet portion, the packet portion corresponding to the packet, such that the encapsulation portion of the encapsulated packet designates the different head switch media access control address, and forwarding the encapsulated packet based, at least in part, on the different head switch media access control address.

### Example Embodiments

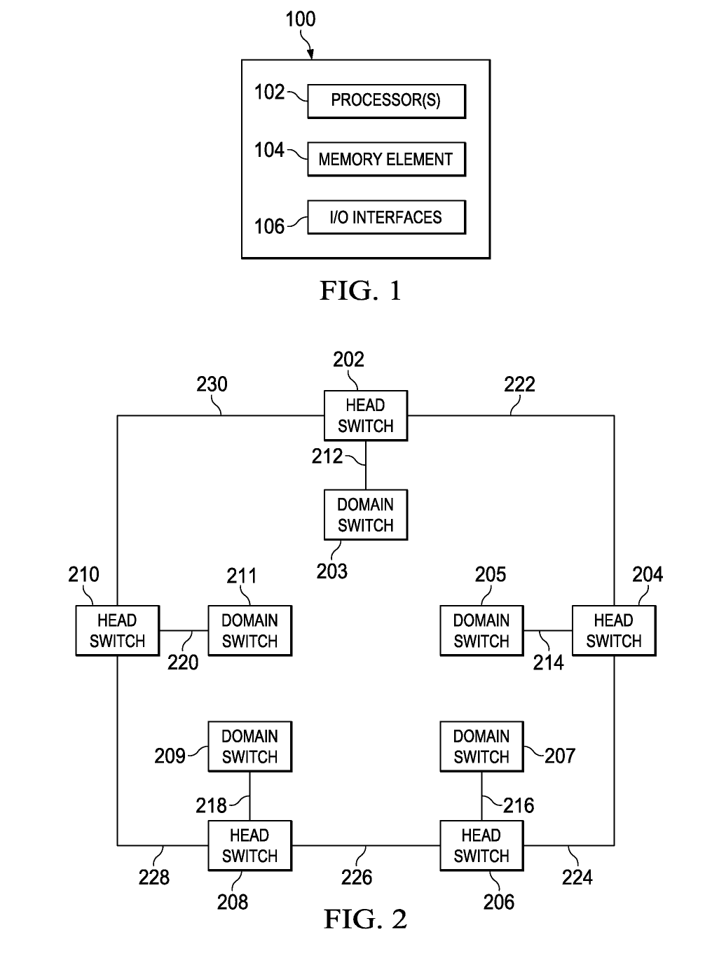

FIG. 1 is a simplified block diagram showing an apparatus according to at least one example embodiment. In the example of FIG. 1, electronic apparatus 100 includes processor(s) 102, memory element 104, and input/output (I/O) interface(s) 106. Processor(s) 102 is configured to execute various tasks of electronic apparatus 100 as described herein and memory element 104 is configured to store data associated with electronic apparatus 100. I/O interface(s) 106 is configured to receive communications from and send communications to other devices, user equipment, servers, network elements, nodes, software modules, and/or the like.

FIG. 2 is a simplified block diagram showing apparatus communication according to at least one example embodiment. The example of FIG. 2 is merely an example and does not limit the scope of the claims. For example, head switch count may vary, domain switch count may vary, communication channels may vary, communication path may vary, and/or the like.

FIG. 2 is a simplified block diagram showing apparatus communication according to at least one example embodiment. In the example of FIG. 2, head switch 202, 204, 206, 208, and 210 each relate to one or more head switches. Each of head switch 202, 204, 206, 208, and 210 may be associated with a CAM table comprising entries associated with domain switches of each head switch's respective head switch domain. Although the example of FIG. 2 illustrates five head switches, the number of head switches may vary. For example, even though FIG. 2 illustrates head switch 202 in communication with a single domain switch 203, in other examples, head switch 202 may be in communication with a plurality of domain switches that may include domain switch 203.

In the example of FIG. 2, domain switch 203, 205, 207, 209, and 211 each relate to one or more domain switches. Although the example of FIG. 2 illustrates five domain switches, the number of domain switches may vary. In the example of FIG. 2, head switch 202 directly communicates with domain switch 203 via communication channel 212. Domain switch 203 may, for example, be associated with the head switch domain of head switch 202. Head switch 204 directly communicates with domain switch 205 via communication channel 214. Domain switch 205 may, for example, be associated with the head switch domain of head switch 204.

Head switch 206 can directly communicate with domain switch 207 via communication channel 216. Domain switch 207 may, for example, be associated with the head switch domain of head switch 206. Head switch 208 directly communicates with domain switch 209 via communication channel 218. Domain switch 209 may, for example, be associated with the head switch domain of head switch 208. Head switch 210 directly communicates with domain switch 211 via communication channel 220. Domain switch 211 may, for example, be associated with the head switch domain of head switch 210.

In some circumstances, it may be desirable to transmit network communications across a network based on a media access control (MAC) address. A MAC address may, for example, relate to a unique identifier assigned to a network interface for communication on a network. In some circumstances, a network communication is transmitted via a switch. A switch may, for example, relate to a network node that links network segments, network nodes, and/or the like. For example, a switch may relate to a multi-port network bridge that processes and switches, routes, transmits, and/or the like data in a network. A switch may, for example, handle data at the data link layer (layer 2), at the network layer (layer 3), and/or the like. Thus, a switch may relate to a layer 2 switch, a layer 3 switch, a multi-layer switch, and/or the like. In such circumstances, a plurality of MAC addresses may be stored by a switch in a content addressable memory (CAM) table. A CAM table may, for example, relate to a dynamic table in a network node, such as a switch, that maps a MAC address to a port of a network node, to an internet protocol address, and/or the like. Such mapping allows for transmission by the switch of network communications towards the destination node.

In at least one example embodiment, a network communication relates to a packet. A packet may, for example, relate to a formatted unit of data carried by and/or over a packet switched network. In some circumstances, a packet may comprise control information, such as header data, footer data, trailer data, and/or the like, and user data, such as a payload, transmitted data, and/or the like. In at least one example embodiment, control information comprises data needed to deliver a user data payload such as source address, destination address, error detection codes, sequencing information, and/or the like. In some circumstances, a switch may communicate a packet towards a destination node via one or more additional switches.

In order to effect the communication of a packet from a first switch to a second switch, the first switch may learn addressing information associated with the second switch. For example, the first switch may discover and store a MAC address associated with the second switch in a CAM table. In some circumstances, there may be a system limitation on a number of MAC addresses a given switch can learn based, at least in part, on the size of the CAM table associated with the switch. For example, a CAM table may be allocated resources sufficient to store a limited number of MAC addresses. Meanwhile, data centers and communication networks are growing at a very fast pace. Such growth may include the addition of network nodes, virtual machines, internet-capable devices, and/or the like. Each additional connected node may be associated with an additional MAC address. In some circumstances, a CAM table may not have the capacity to learn all associated MAC addresses. In such circumstances, it may be desirable to, directly or indirectly, increase CAM table capacity and, therefore, MAC address learning capacity.

In one or more example embodiments, a switch that communicates with one or more additional switches relates to a head switch. For example, a head switch may receive a packet and transmit the packet towards a destination node via a different switch. In at least one example embodiment, a head switch relates to a head switch domain designating at least one range of internet protocol (IP) addresses. An IP address may, for example, relate to a numerical label assigned to a network node participating in a network utilizing internet protocol for communication. For example, an IP address may provide host addressing, network interface identification, location addressing, destination addressing, source addressing, and/or the like. A head switch domain may, for example, relate to a domain with which a head switch communicates packets. In such an example, the domain may be associated with one or more range of IP addresses, sets of IP addresses, and/or the like. In at least one example embodiment, a domain switch relates to a switch belonging to a specific domain. In at least one example embodiment, a head switch relates to a head switch domain designating at least one range of internet protocol addresses such that a domain switch has an internet protocol address within the range of internet protocol addresses designated by the head switch. In at least one example embodiment, a head switch comprises a CAM table comprising addressing information associated with domain switches within a head switch domain.

In at least one example embodiment, a head switch receives a packet that comprises information indicative of a destination media access control address and a destination domain address. In such an example, receiving a packet may relate to receiving of packet data via a network, receiving of packet data from at least one memory, initiation of a data transfer between two network nodes and direct or indirect receiving of such data, and/or the like. The packet control information may, for example, include a destination MAC address, a destination domain address, and/or the like. In such an example, the destination MAC address may relate to a MAC address of a destination node. A destination node may, for example, relate to an intended recipient of a packet, a network node located in a patch to the destination node, a switch, a router, a server, and/or the like. A destination domain address may, for example, relate to a domain address of a destination node. In such an example, the domain address may relate to an IP address, a set of IP addresses, destination node address data, a port number, and/or the like.

In order to effect communication of the received packet, a head switch may access a CAM table associated with the head switch and the head switch domain. For example, the head switch may perform a layer 2 look-up within the CAM table based, at least in part, on the received destination MAC address and the destination domain address. A layer 2 look-up may, for example, relate to accessing a CAM table and determining a domain address based, at least in part, on a MAC address. For example, once a head switch receives a packet comprising information indicative of a destination MAC address and a destination domain address, the head switch may access an associated CAM table based, at least in part, on the destination MAC address in order to determine information indicative of an address of the destination node. In one or more example embodiments, a CAM table associated with a head switch comprises entries associated with one or more domain switches associated with a head switch domain.

In some circumstances, due to system limitations, memory limitations, and/or the like, a CAM table may be able to store a limited number of entries. For example, a CAM table associated with a head switch may be unable to store addressing data for every network node associated with the head switch. In such an example, it may desirable to effectively expand the storage capacity of the CAM table. In at least one example embodiment, a single CAM table is distributively stored on one or more head switches. For example, in order to increase the storage capacity of a CAM table, the CAM table may be split among a head switch, a different head switch, and/or the like. In such an example, the head switch and the different head switch may be associated with a head switch domain and a different head switch domain. The different head switch may, for example, be identified by a different head switch MAC address. In at least one example embodiment, a head switch relates to a switch that forwards packets to at least one domain switch and at least one different head switch. Forwarding of a packet may, for example, relate to retransmission of a received packet, transmission of information indicative of a received packet, modification, and transmission of a received packet, and/or the like. A packet may be forwarded based, at least in part, on the packet's control information, the destination MAC address, the domain address, and/or the like. In at least one example embodiment, a head switch may be associated with a head switch domain and a different head switch may be associated with a different head switch domain. In such an example embodiment, the head switch domain may be associated with one or more domain switches and the different head switch domain may be associated with one or more different domain switches. The different head switch may, for example, be absent a direct communication channel a domain switch associated with a head switch domain of a head switch. In such an example, the different head switch may be in direct communication with one or more different domain switches associated with the different head switch domain and/or one or more other head switches. In one or more example embodiments, a head switch relates to a head switch domain designating at least one range of internet protocol addresses such that a different head switch has an internet protocol address beyond the range of internet protocol addresses designated by the head switch. For example, unlike a domain switch associated with a head switch and a head switch domain, a different head switch avoids association with the head switch domain.

In some circumstances, a head switch may receive a packet comprising a destination MAC address and a domain address associated with a different domain switch associated with a different head switch domain associated with a different head switch. For example, since CAM data may be distributively stored across a plurality of head switches, a head switch may receive a packet directed to a destination MAC address that is not identified within the head switch's CAM table. In at least one example embodiment, a head switch determines that a destination media access control address fails to correlate with at least one stored media access control address comprised by a content addressable memory table. In one or more example embodiments, determination that a destination media access control address fails to correlate with at least one stored media access control address comprised by a content addressable memory table relates to a layer two miss. A layer two miss may, for example, relate to a failed attempt to correlate a destination MAC address with an entry in a CAM table, a destination MAC address failing to correlate with a stored MAC address, and/or the like. A stored MAC address may, for example, relate to a MAC address portion of an entry within a CAM table. In such an example, the destination MAC address may, instead, be associated with a stored MAC address within a different CAM table associated with a different head switch. In such an example, the head switch may cause forwarding of the packet to the different head switch based, at least in part, on the different head switch MAC address. In at least one example embodiment, a head switch determines a different head switch media access control address based, at least in part, on a destination domain address. For example, the head switch may cause forwarding of the received packet to the different head switch based, at least in part, on the destination domain address associated with the received packet. In at least one example embodiment, a determination of a different head switch media access control address relates to a layer three lookup based, at least in part, on the destination domain address. A layer three lookup may, for example, relate to a lookup based, at least in part, on a domain address, an IP address, and/or the like. In at least one example embodiment, determination of a different head switch media access control address comprises retrieving the different head switch media access control address from at least one memory based, at least in part, on a destination domain address.

In order to forward a received packet from a head switch and to a different head switch, it may be desirable to encapsulate the received packet prior to forwarding. In at least one example embodiment, a head switch generates an encapsulated packet that comprises at least one encapsulation portion and at least one packet portion, the packet portion corresponding to a received packet for subsequent forwarding, such that the encapsulation portion of the encapsulated packet designates a different head switch media access control address. For example, in order to effect the forwarding of a packet received at a head switch to a different head switch designated by the determined different head switch MAC address, the head switch may encapsulate the received packet such that the encapsulation portion of the received packet designates the different head switch and the packet portion corresponds to the received packet. In one or more example embodiments, a head switch forwards an encapsulated packet to a different head switch based, at least in part, on a different head switch media access control address. In at least one example embodiment, a destination media access control address associated with a received packet identifies another head switch and forwarding of the packet relates to forwarding the packet to the other head switch.

In some circumstances, a head switch may receive a packet comprising a destination MAC address and a domain address associated with a domain switch associated with a head switch domain associated with the head switch. In such circumstances, the head switch may determine that the destination MAC address correlates with a stored MAC address associated with an entry with a CAM table associated with the head switch. Correlation between a stored MAC address and a destination MAC address may, for example, relate to a layer two hit. In at least one example embodiment, a head switch forwards a packet to a domain switch associated with the head switch domain based, at least in part, on the a destination media access control address. For example, if the head switch receives a packet designating a destination MAC address associated with a domain switch, the head switch may cause forward of the packet to the domain switch. In at least one example embodiment, a destination media access control address identifies a domain switch and forwarding of a packet relates to forwarding the different packet to the domain switch.

In the example of FIG. 2, head switch 202 communicates with head switch 204 via communication channel 222, head switch 204 communicates with head switch 206 via communication channel 224, head switch 206 communicates with head switch 208 via communication channel 226, head switch 208 communicates with head switch 210 via communication channel 228, and head switch 210 communicates with head switch 202 via communication channel 230. Although FIG. 2 illustrates a ring network configuration of the head switches, additional communication channels may exist between the various head switches.

Each of head switches 202, 204, 206, 208, and 210 may receive a packet from another network node and forward the received packet to one or more of the other head switches. In the case of forwarding a received packet to a domain switch, however, each of head switches 202, 204, 206, 208, and 210 may limit forwarding of the received packet to the associated domain switch associated with the received packet. For example, head switch 202 may directly forward a received packet to domain switch 203 via communication channel 212. Alternatively, head switch 202 may be limited from directly forwarding a received packet to domain switch 205. Instead, head switch 202 may indirectly cause forwarding of a received packet to domain switch 205 by encapsulating the received packet such that the encapsulation portion of the encapsulated packet designates head switch 204 and forwarding the encapsulated packet to head switch 204 which, in turn, may strip the encapsulation portion from the received encapsulated packet and forward the packet portion to domain switch 205.

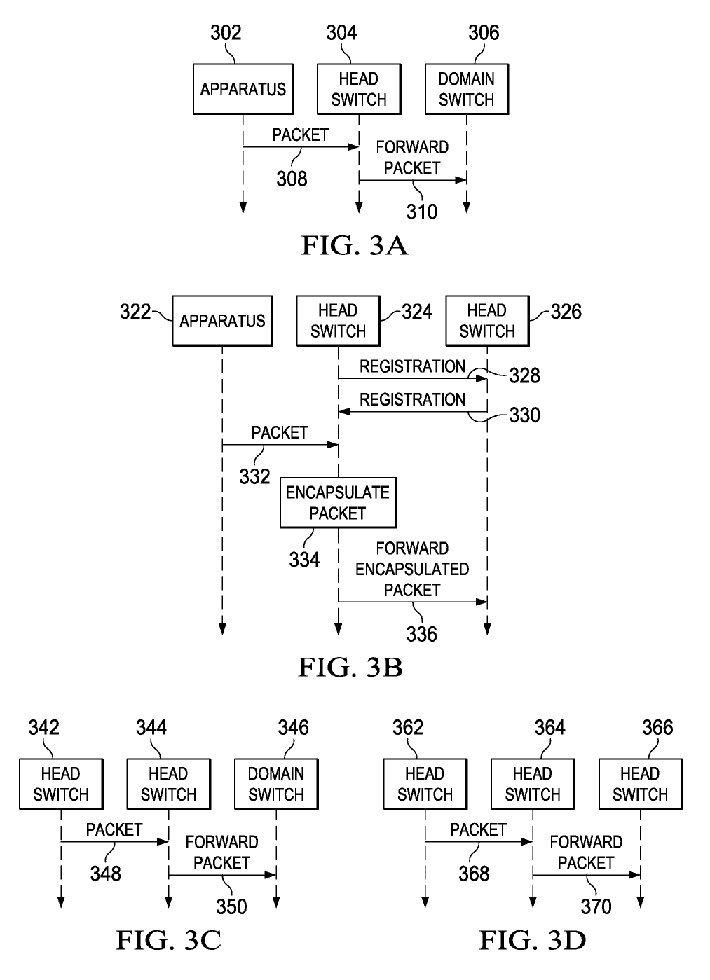

FIGS. 3A-3D are simplified interaction diagrams showing activities associated with forwarding of a packet according to at least one example embodiment. In at least one example embodiment, there is a set of operations that corresponds with, at least some of, the activities of FIGS. 3A-3D. For example, there may be a set of operations associated with activities of one or more apparatuses of FIGS. 3A-3D. An apparatus, for example electronic apparatus 100 of FIG. 1, or a portion thereof, may utilize the set of operations. The access point may comprise means, including, for example processor(s) 102 of FIG. 1, for performance of such operations. In an example embodiment, an apparatus, for example electronic apparatus 100 of FIG. 1, is transformed by having memory, for example memory element 104 of FIG. 1, comprising computer code configured to, working with a processor, for example processor(s) 102 of FIG. 1, cause the apparatus to perform set of operations of FIGS. 3A-3D.

In order to generate the forwarding of a received packet from a head switch to a different head switch, it may be desirable for a head switch to have knowledge of the different head switch and its associated different head switch MAC address, different head switch domain, destination domain address, and/or the like. For example, without knowledge of such information, a head switch may be unable to forward a received packet designating a domain switch associated with a different head switch domain. In such an example, the head switch may be unable to locate address information for the corresponding different head switch. In one or more example embodiments, a head switch receives a different head switch registration that comprises the different head switch media access control address and the destination domain address. In such an embodiment, the head switch may store the different head switch media access control address and the destination domain address in its associated CAM table. In one or more example embodiments, the different head switch registration may be received from a different head switch identified by the different head switch media access control address. In at least one example embodiment, a head switch receives information indicative of a different head switch configuration that comprises the different head switch media access control address and the destination domain address. The information indicative of the different head switch configuration may, for example, relate to network configuration information, a head switch parameter information, and/or the like. In at least one example embodiment, the information indicative of the different head switch configuration may be received from a configuration file, an administration termination, and/or the like. Similarly, a head switch may cause sending of its head switch registration that comprises a head switch media access control address that identifies the head switch and the destination domain address to a different head switch.

FIG. 3A is a simplified interaction diagram showing activities associated with forwarding of a packet according to at least one example embodiment. In the example of FIG. 3A, apparatus 302 relates to a network node, a server, a switch, a router, and/or the like. In the example of FIG. 3A, head switch 304 relates to at least one head switch. In the example of FIG. 3A, domain switch 306 relates to at least one domain switch associated with a head switch domain of head switch 304. At interaction 308, head switch 304 receives a packet sent from apparatus 302. In the example of FIG. 3A, head switch 304 determines that the destination MAC address associated with the received packet correlates with at least one stored MAC address comprised by a CAM table of head switch 304. Based, at least in part, on this correlation, at interaction 310, head switch 304 forwards the received packet to domain switch 306.

FIG. 3B is a simplified interaction diagram showing activities associated with forwarding of a packet according to at least one example embodiment. In the example of FIG. 3B, head switch 324 sends head switch registration 328 to head switch 326. Head switch 326 sends head switch registration 330 to head switch 324. In the example of FIG. 3B, although registration 330 is illustrated as occurring subsequent to registration 328, registration 328 may be performed subsequent to registration 330. Each of registrations 328 and 330 may relate to retrieval of registration information from at least one memory, receipt of head switch configuration information, receipt of a head switch registration, and/or the like. At interaction 332, head switch 324 receives a packet sent from apparatus 322. In the example of FIG. 3B, head switch 324 determines that the destination MAC address associated with the received packet fails to correlate with at least one stored MAC address comprised by its associated CAM table. Based, at least in part, on the failure to correlate, head switch 324 determines a different head switch MAC address based on the destination domain address of the received packet. Based upon the previously received registration of head switch 326, head switch 324 determines a different head switch MAC address associated with head switch 326 and, at block 334, generates an encapsulated packet comprising at least one encapsulation portion designating head switch 326 and at least one packet portion corresponding to the received packet. At interaction 336, head switch 324 forwards the encapsulated packet to head switch 326.

FIG. 3C is a simplified interaction diagram showing activities associated with forwarding of a packet according to at least one example embodiment. In the example of FIG. 3C, at interaction 348, head switch 342 forwards a packet to head switch 344. The forwarded packet may relate to an encapsulated packet comprising at least one encapsulation portion designating head switch 344 and at least one packet portion corresponding to a packet previously received and encapsulated at head switch 342. Head switch 344 receives the encapsulated packet. In the example of FIG. 3C, head switch 344 determines that the destination MAC address associated with the received packet correlates with at least one stored MAC address comprised by a CAM table of head switch 344, the stored MAC address relating to a domain switch, domain switch 346. Based, at least in part, on this correlation, at interaction 350, head switch 344 causes forwarding of the packet portion of the received encapsulated packet to domain switch 346.

FIG. 3D is a simplified interaction diagram showing activities associated with forwarding of a packet according to at least one example embodiment. In the example of FIG. 3D, at interaction 368, head switch 362 forwards a packet to head switch 364. The forwarded packet may relate to an encapsulated packet comprising at least one encapsulation portion designating head switch 364 and at least one packet portion corresponding to a packet previously received and encapsulated at head switch 362. Head switch 364 receives the encapsulated packet. In the example of FIG. 3D, head switch 364 determines that the destination MAC address associated with the received packet does not correlates with at least one stored MAC address comprised by a CAM table of head switch 364, the stored MAC address relating to a different head switch, head switch 366. Based, at least in part, on this correlation, at interaction 370, head switch 364 causes forwarding of the received encapsulated packet to domain switch 346. In the example of FIG. 3D, head switch 364 may re-encapsulate the received encapsulated packet such that the encapsulation portion of the re-encapsulated packet designated head switch 366.

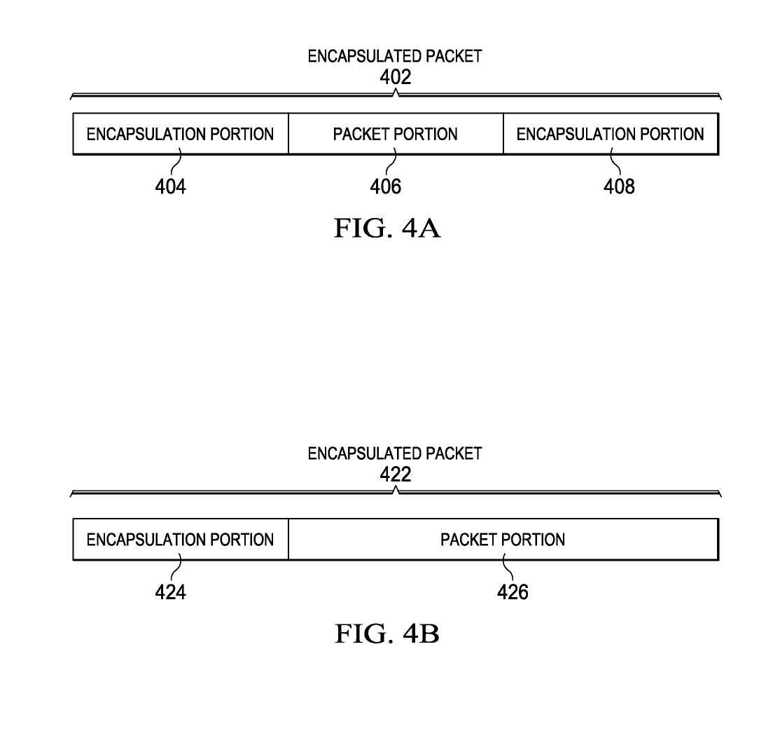

FIGS. 4A-4B are simplified block diagrams showing encapsulation of a packet according to at least one example embodiment. The examples of FIGS. 4A-4B are merely examples and do not limit the scope of the claims. For example, encapsulation portion count, order, size, and/or arrangement may vary, packet portion count, order, size, and/or arrangement may vary, and/or the like.

FIG. 4A is a simplified block diagram showing encapsulation of a packet according to at least one example embodiment. In the example of FIG. 4A, encapsulated packet 402 comprises encapsulation portion 404, packet portion 406, and encapsulation portion 408. In the example of FIG. 4A, encapsulation portion 404 relates to a packet header, a user datagram protocol header, an internet protocol header, a frame header, and/or the like. In the example of FIG. 4A, packet portion 406 relates to packet data, forwarded packet data, user datagram protocol data, internet protocol data, frame data, and/or the like. In the example of FIG. 4A, encapsulation portion 408 relates to a packet footer, a user datagram protocol footer, an internet protocol footer, a frame footer, and/or the like.

FIG. 4B is a simplified block diagram showing encapsulation of a packet according to at least one example embodiment. In the example of FIG. 4B, encapsulated packet 422 comprises encapsulation portion 424 and packet portion 426. In the example of FIG. 4B, encapsulation portion 424 relates to a packet header, a user datagram protocol header, an internet protocol header, a frame header, and/or the like. In the example of FIG. 4B, packet portion 426 relates to packet data, forwarded packet data, user datagram protocol data, internet protocol data, frame data, and/or the like. As shown in the example of FIG. 4B, encapsulated packet 422 lacks the second encapsulation portion, shown as encapsulation portion 408 in FIG. 4A. Additionally, packet portion 426 of encapsulated packet 422 may relate to one or more encapsulated packets, each having at least one encapsulation portion and at least one packet portion.

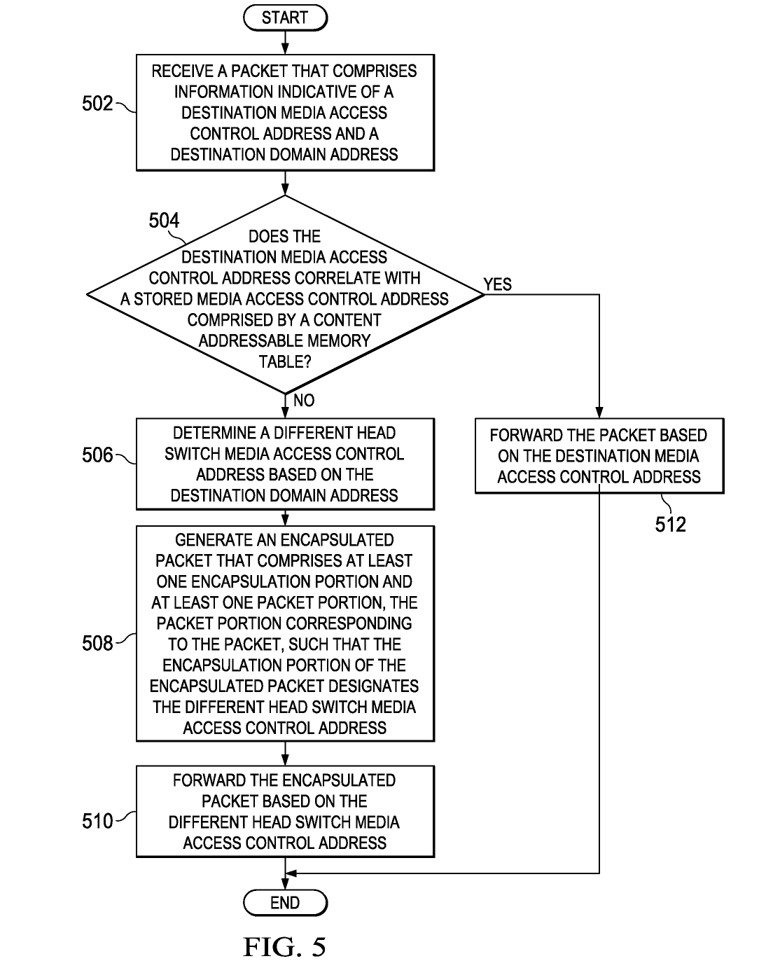

FIG. 5 is a simplified flowchart showing activities associated with performing resource allocation according to at least one example embodiment. In at least one example embodiment, there is a set of operations that corresponds with the activities of FIG. 5. An apparatus, for example electronic apparatus 100 of FIG. 1, or a portion thereof, may utilize the set of operations. The electronic apparatus may comprise means, including, for example processor(s) 102 of FIG. 1, for performance of such operations. In an example embodiment, an apparatus, for example, electronic apparatus 100 of FIG. 1, is transformed by having memory, for example, memory element 104 of FIG. 1, comprising computer code configured to, working with a processor, for example, processor(s) 102 of FIG. 1, cause the apparatus to perform set of operations of FIG. 5.

At block 502, the apparatus receives a packet that comprises information indicative of a destination media access control address and the destination domain address, similar as described regarding FIG. 2 and FIGS. 3A-3D. At block 504, the apparatus determines whether the destination media access control address correlate with a stored media access control address comprised by a content addressable memory table, similar as described regarding FIG. 2 and FIGS. 3A-3D. If the destination media access control address fails to correlate with a stored media access control address, flow proceeds to block 506. If the destination media access control address correlates with a stored media access control address, flow proceeds to block 512.

At block 506, the apparatus determines a different head switch media access control address based on the destination domain address, similar as described regarding FIG. 2 and FIGS. 3A-3D. In this manner, determining a different head switch media access control address may be based, at least in part, on a determination that the destination media access control address fails to correlate with a stored media access control address comprised by the content addressable memory table.

At block 508, the apparatus generates an encapsulated packet that comprises at least one encapsulation portion and at least one packet portion, the packet portion corresponding to the packet, such that the encapsulation portion of the encapsulated packet designates the different head switch media access control address, similar as described regarding FIG. 2, FIGS. 3A-3D, and FIGS. 4A-4B.

At block 510, the apparatus forwards the encapsulated packet based on the different head switch media access control address, similar as described regarding FIG. 2, FIGS. 3A-3D, and FIGS. 4A-4B.

At block 512, the apparatus forwards the packet based on the destination media access control address, similar as described regarding FIG. 2 and FIGS. 3A-3D. In this manner, forwarding of the packet may be based, at least in part, on a determination that the destination media access control address correlates with a stored media access control address comprised by the content addressable memory table.

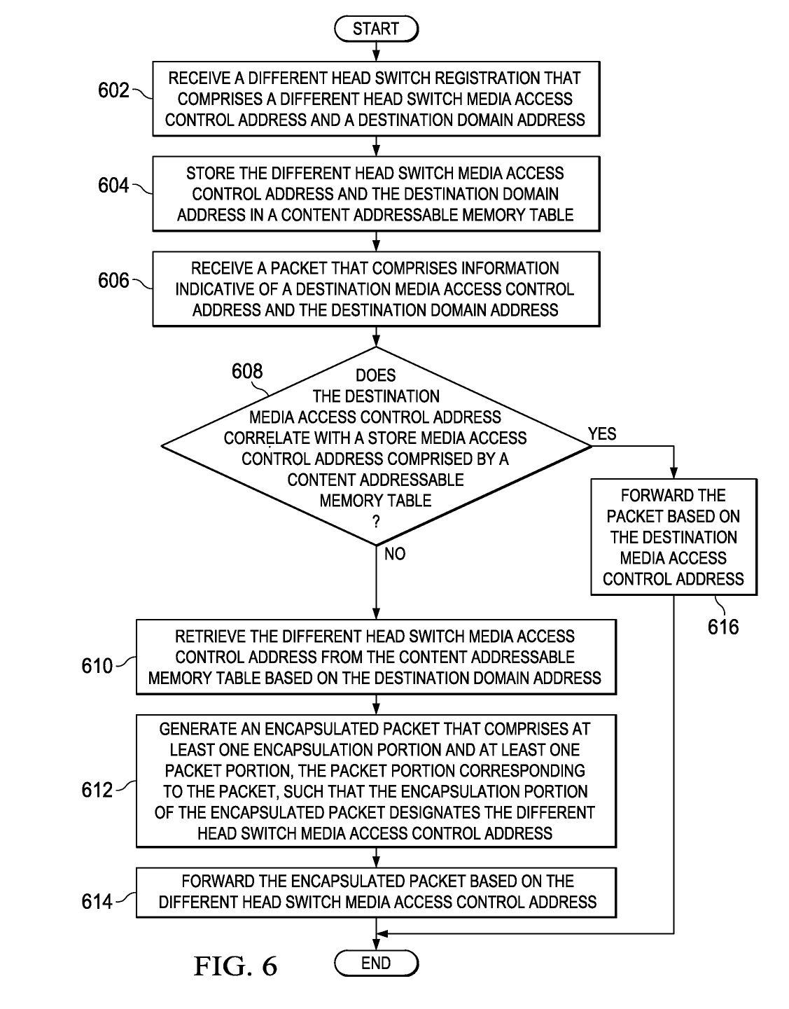

FIG. 6 is a simplified flowchart showing activities associated with performing resource allocation according to at least one example embodiment. In at least one example embodiment, there is a set of operations that corresponds with the activities of FIG. 6. An apparatus, for example electronic apparatus 100 of FIG. 1, or a portion thereof, may utilize the set of operations. The electronic apparatus may comprise means, including, for example processor(s) 102 of FIG. 1, for performance of such operations. In an example embodiment, an apparatus, for example, electronic apparatus 100 of FIG. 1, is transformed by having memory, for example, memory element 104 of FIG. 1, comprising computer code configured to, working with a processor, for example, processor(s) 102 of FIG. 1, cause the apparatus to perform set of operations of FIG. 6.

At block 602, the apparatus receives a different head switch registration that comprises a different head switch media access control address and a destination domain address, similar as described regarding FIG. 2 and FIGS. 3A-3D. At block 604, the apparatus stores the different head switch media access control address and the destination domain address in a content addressable memory table, similar as described regarding FIG. 2 and FIGS. 3A-3D.

At block 606, the apparatus receives a packet that comprises information indicative of a destination media access control address and the destination domain address, similar as described regarding block 502 of FIG. 5. At block 608, the apparatus determines whether the destination media access control address correlate with a stored media access control address comprised by the content addressable memory table, similar as described regarding block 504 of FIG. 5. If the destination media access control address fails to correlate with a stored media access control address, flow proceeds to block 610. If the destination media access control address correlates with a stored media access control address, flow proceeds to block 616.

At block 610, the apparatus retrieves the different head switch media access control address from the content addressable memory table based on the destination domain address, similar as described regarding FIG. 2 and FIGS. 3A-3D. In this manner, retrieving of the different head switch media access control address from the content addressable memory table may be based, at least in part, on a determination that the destination media access control address fails to correlate with a stored media access control address comprised by the content addressable memory table.

At block 612, the apparatus generates an encapsulated packet that comprises at least one encapsulation portion and at least one packet portion, the packet portion corresponding to the packet, such that the encapsulation portion of the encapsulated packet designates the different head switch media access control address, similar as described regarding block 508 of FIG. 5. At block 614, the apparatus forwards the encapsulated packet based on the different head switch media access control address, similar as described regarding block 510 of FIG. 5. At block 616, the apparatus forwards the packet based on the destination media access control address, similar as described regarding block 512 of FIG. 5. In this manner, forwarding of the packet may be based, at least in part, on a determination that the destination media access control address correlates with a stored media access control address comprised by the content addressable memory table.

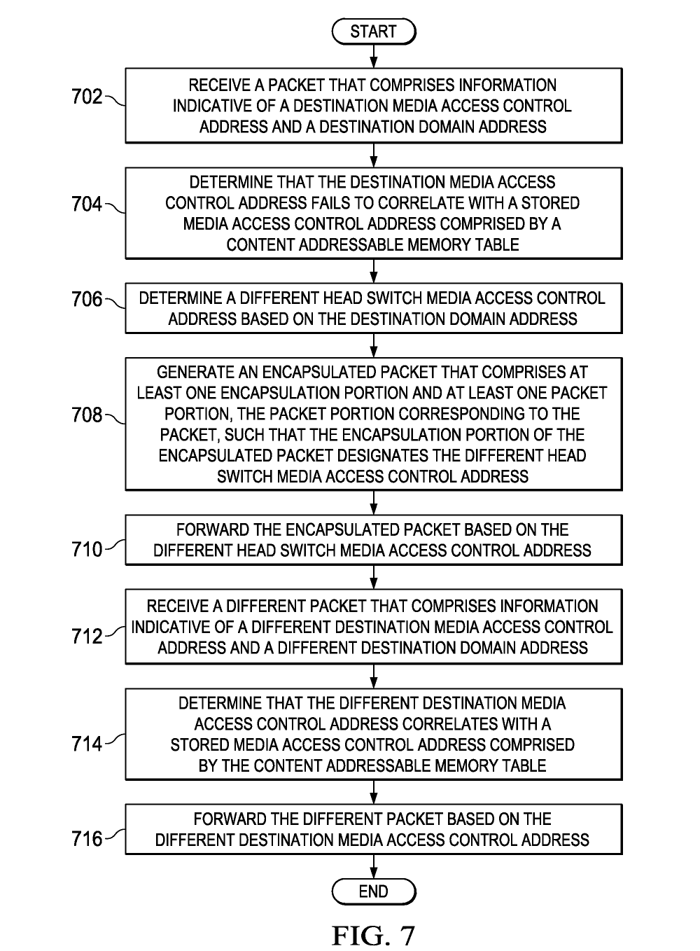

FIG. 7 is a simplified flowchart showing activities associated with performing resource allocation according to at least one example embodiment. In at least one example embodiment, there is a set of operations that corresponds with the activities of FIG. 7. An apparatus, for example electronic apparatus 100 of FIG. 1, or a portion thereof, may utilize the set of operations. The electronic apparatus may comprise means, including, for example processor(s) 102 of FIG. 1, for performance of such operations. In an example embodiment, an apparatus, for example, electronic apparatus 100 of FIG. 1, is transformed by having memory, for example, memory element 104 of FIG. 1, comprising computer code configured to, working with a processor, for example, processor(s) 102 of FIG. 1, cause the apparatus to perform set of operations of FIG. 7.

At block 702, the apparatus receives a packet that comprises information indicative of a destination media access control address and a destination domain address, similar as described regarding block 502 of FIG. 5. At block 704, the apparatus determines that the destination media access control address fails to correlate with a stored media access control address comprised by a content addressable memory table, similar as described regarding FIG. 2 and FIGS. 3A-3D.

At block 706, the apparatus determines a different head switch media access control address based on the destination domain address, similar as described regarding block 506 of FIG. 5. At block 708, the apparatus generates an encapsulated packet that comprises at least one encapsulation portion and at least one packet portion, the packet portion corresponding to the packet, such that the encapsulation portion of the encapsulated packet designates the different head switch media access control address, similar as described regarding block 508 of FIG. 5.

At block 710, the apparatus forwards the encapsulated packet based on the different head switch media access control address, similar as described regarding block 510 of FIG. 5. At block 712, the apparatus receives a different packet that comprises information indicative of a different destination media access control address and a different destination domain address, similar as described regarding FIG. 2 and FIGS. 3A-3D. At block 714, the apparatus determines that the different destination media access control address correlates with a stored media access control address comprised by the content addressable memory table, similar as described regarding FIG. 2 and FIGS. 3A-3D. At block 716, the apparatus forwards the different packet based on the different destination media access control address, similar as described regarding FIG. 2 and FIGS. 3A-3D.

In general terms, head switches and domain switches are electronic apparatuses that can facilitate resolving the MAC scaling issues discussed herein. As used herein in this Specification, the term ‘apparatus’ is meant to encompass any of the aforementioned elements, as well as routers, switches, cable boxes, gateways, bridges, data center elements, loadbalancers, firewalls, inline service nodes, proxies, servers, customer premises equipment (CPE), processors, modules, or any other suitable device, component, element, proprietary appliance, or object operable to exchange information in a network environment. These apparatuses may include any suitable hardware, software, components, modules, interfaces, or objects that facilitate the operations thereof. This may be inclusive of appropriate algorithms and communication protocols that allow for the effective exchange of data or information.

In one implementation, any of the apparatuses include software to achieve (or to foster) the MAC scaling resolution activities discussed herein. Additionally, each of these elements can have an internal structure (e.g., a processor, a memory element, etc.) to facilitate some of the operations described herein. In other embodiments, these MAC scaling resolution activities may be executed externally to these elements, or included in some other apparatuses to achieve the intended functionality. Alternatively, each apparatus may include software (or reciprocating software) that can coordinate with other apparatuses in order to achieve the MAC scaling resolution activities described herein. In still other embodiments, one or several devices may include any suitable algorithms, hardware, software, components, modules, interfaces, or objects that facilitate the operations thereof.

In certain example implementations, the MAC scaling resolution functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor [processor shown in FIG. 1], or other similar machine, etc.). In some of these instances, a memory element [memory shown in FIG. 1] can store data used for the operations described herein. This includes the memory element being able to store instructions (e.g., software, code, etc.) that are executed to carry out the activities described in this Specification. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the apparatuses, etc.) can include memory elements for storing information to be used in achieving the MAC scaling resolution activities, as outlined herein. Additionally, each of these devices may include a processor that can execute software or an algorithm to perform the MAC scaling resolution activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the apparatuses can also include suitable interfaces for receiving, transmitting, and/or otherwise communicating data or information in a network environment.

It is important to note that the steps in the preceding flow diagrams illustrate only some of the possible signaling scenarios and patterns that may be executed by, or within, electronic apparatus 100. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. If desired, the different functions discussed herein may be performed in a different order and/or concurrently with each other. For example, blocks 712, 714, and 716 of FIG. 7 may be performed before block 702 of FIG. 7. Furthermore, if desired, one or more of the above-described functions may be optional or may be combined. For example, block 610 of FIG. 6 may be optional and/or combined with block 612 of FIG. 6. The preceding operational flows have been offered for purposes of example and discussion. Substantial flexibility is provided by electronic apparatus 100 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers and clients in certain implementations of the present disclosure. Moreover, the present disclosure can readily be extended to apply to intervening servers further upstream in the architecture. Any such permutations, scaling, and configurations are clearly within the broad scope of the present disclosure.

Although the present disclosure has been described in detail with reference to particular arrangements and configurations, these example configurations and arrangements may be changed significantly without departing from the scope of the present disclosure. Additionally, although electronic apparatus 100 has been illustrated with reference to particular elements and operations that facilitate the communication process, these elements and operations may be replaced by any suitable architecture or process that achieves the intended functionality of electronic apparatus 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. An apparatus, comprising:
at least one processor;
at least one memory including computer program code, the memory and the computer program code configured to, working with the processor, cause the apparatus to perform at least the following:
receive a packet that comprises information indicative of a destination media access control address and a destination domain address;
determine that the destination media access control address fails to correlate with at least one stored media access control address comprised by a content addressable memory table;
determine a different head switch media access control address based, at least in part, on the destination domain address;
generate an encapsulated packet that comprises at least one encapsulation portion and at least one packet portion, the packet portion corresponding to the packet, such that the encapsulation portion of the encapsulated packet designates the different head switch media access control address; and
forward the encapsulated packet based, at least in part, on the different head switch media access control address.

2. The apparatus of claim 1, wherein the apparatus relates to a switch that forwards packets to at least one domain switch and at least one different head switch.

3. The apparatus of claim 1, wherein the determination of the different head switch media access control address comprises retrieving the different head switch media access control address from at least one memory based, at least in part, on the destination domain address.

4. The apparatus of claim 3, wherein the memory further includes computer program instructions that, when executed by the at least one processor, cause the apparatus to perform:
receipt of a different head switch registration that comprises the different head switch media access control address and the destination domain address; and
storage of the different head switch media access control address and the destination domain address in the content addressable memory table.

5. The apparatus of claim 3, wherein the memory further includes computer program instructions that, when executed by the at least one processor, cause the apparatus to perform receipt of information indicative of a different head switch configuration that comprises the different head switch media access control address and the destination domain address.

6. The apparatus of claim 1, wherein the memory further includes computer program instructions that, when executed by the at least one processor, cause the apparatus to perform:
receipt of a different packet that comprises information indicative of a different destination media access control address and a different destination domain address;
determination that the different destination media access control address correlates with a stored media access control address comprised by the content addressable memory table; and
forwarding of the different packet based, at least in part, on the different destination media access control address.

7. The apparatus of claim 6, wherein the different destination media access control address identifies a domain switch and forwarding of the different packet relates to forwarding the different packet to the domain switch.

8. The apparatus of claim 6, wherein the different destination media access control address identifies another different head switch and forwarding of different packet relates to forwarding the different packet to the other different head switch.

9. The apparatus of claim 1, wherein the memory further includes computer program instructions that, when executed by the at least one processor, cause the apparatus to perform sending of a head switch registration that comprises a head switch media access control address that identifies the apparatus and the destination domain address.

10. A method, comprising:
Receiving, at an apparatus, a packet that comprises information indicative of a destination media access control address and a destination domain address;
determining that the destination media access control address fails to correlate with at least one stored media access control address comprised by a content addressable memory table;
determining a different head switch media access control address based, at least in part, on the destination domain address;
generating an encapsulated packet that comprises at least one encapsulation portion and at least one packet portion, the packet portion corresponding to the packet, such that the encapsulation portion of the encapsulated packet designates the different head switch media access control address; and
forwarding the encapsulated packet based, at least in part, on the different head switch media access control address.

11. The method of claim 10, wherein the apparatus switch relates to a switch that forwards packets to at least one domain switch and at least one different head switch.

12. The method of claim 10, wherein the determination of the different head switch media access control address comprises retrieving the different head switch media access control address from at least one memory based, at least in part, on the destination domain address.

13. The method of claim 12, further comprising:
receiving of a different head switch registration that comprises the different head switch media access control address and the destination domain address; and
storing of the different head switch media access control address and the destination domain address in the content addressable memory table.

14. The method of claim 12, further comprising receipt of information indicative of a different head switch configuration that comprises the different head switch media access control address and the destination domain address.

15. The method of claim 10, further comprising:
receiving of a different packet that comprises information indicative of a different destination media access control address and a different destination domain address;
determining that the different destination media access control address correlates with a stored media access control address comprised by the content addressable memory table; and
forwarding of the different packet based, at least in part, on the different destination media access control address.

16. The method of claim 10, further comprising sending of a head switch registration that comprises a head switch media access control address that identifies a head switch and the destination domain address.

17. At least one computer-readable medium encoded with instructions that, when executed by a processor, perform:
receiving, at a head switch, a packet that comprises information indicative of a destination media access control address and a destination domain address;
determining that the destination media access control address fails to correlate with at least one stored media access control address comprised by a content addressable memory table;
determining a different head switch media access control address based, at least in part, on the destination domain address;
generating an encapsulated packet that comprises at least one encapsulation portion and at least one packet portion, the packet portion corresponding to the packet, such that the encapsulation portion of the encapsulated packet designates the different head switch media access control address; and
forwarding the encapsulated packet based, at least in part, on the different head switch media access control address.

18. The medium of claim 17, wherein the determination of the different head switch media access control address comprises retrieving the different head switch media access control address from at least one memory based, at least in part, on the destination domain address.

19. The medium of claim 18, encoded with instructions that, when executed by a processor, perform:
receiving of a different head switch registration that comprises the different head switch media access control address and the destination domain address; and
storing of the different head switch media access control address and the destination domain address in the content addressable memory table.

20. The medium of claim 17, encoded with instructions that, when executed by a processor, perform:
receiving of a different packet that comprises information indicative of a different destination media access control address and a different destination domain address;
determining that the different destination media access control address correlates with a stored media access control address comprised by the content addressable memory table; and
forwarding of the different packet based, at least in part, on the different destination media access control address.
